(19) United States
(12) Patent Application Publication
(10) Pub. No.: US 2020/0349522 A1
(43) Pub. Date: Nov. 5, 2020

(54) SYSTEMS AND METHODS FOR DATA VALIDATION

(71) Applicant: CSK TECHNOLOGIES, LLC, St. Louis, MO (US)

(72) Inventor: Darryl Clines, St. Louis, MO (US)

(21) Appl. No.: 16/865,863

(22) Filed: May 4, 2020

Related U.S. Application Data
(60) Provisional application No. 62/843,034, filed on May 3, 2019.

(51) Int. Cl. G06Q 10/10; G06F 16/953; G06F 40/174

(52) U.S. Cl. CPC G06Q 10/1053; G06F 40/174; G06F 16/953

(57) ABSTRACT

Systems and methods for evidence-based validation of user-supplied information. The systems and methods include automated validation as well as supplemental manual validation. The validation is in the context of an on-line platform for employment-related data used by candidates for jobs, employers seeking new hires, and public agencies managing employment-related benefits.

### CROSS-REFERENCE TO RELATED APPLICATIONS

This application claims the benefit of U.S. Prov. Pat. App. No. 62/843,034, filed May 3, 2019, the entire disclosure of which is incorporated herein by reference.

### BACKGROUND OF THE :INVENTION

### Field of the Invention

This disclosure is related to the field of data validation, and more particularly to systems and methods for automated data validation via independent external, third party data sources.

### Description of the Related Art

Data validation is the process of ensuring that data is of adequate quality for a particular purpose, such as by removing erroneous records. In some applications, this can be done automatically to correct and remove errors. For example, if a dataset contains a list of hire dates for current employees, a hire date more than a century old can be assumed to be erroneous. However, in other circumstances, it is more difficult to apply constraints or rules. For example, where an employee is submitting background information about prior employment and educational qualifications, each potential employer must independently verify the information provided by contacting the prior employers or educational institutions. This type of manual confirmation is time-consuming, expensive, and duplicative, because each potential employer must conduct the same verification. This problem is particularly acute in employment-related contexts, such as hiring job candidates or assessing eligibility for unemployment benefits.

### SUMMARY OF THE INVENTION

The following is a summary of the invention in order to provide a basic understanding of sonic aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for automatically populating a virtual resume comprising: providing a computer server providing network services to client devices over a telecommunications network, said network services comprising a job candidate-employer search platform; at said computer server, receiving from an employer user via said telecommunications network, a name of said employer and employment data about a plurality of employees of said employer, said employment data for each employee in said plurality comprising a hire date, termination date, job title, and identifier for said each employee; at said computer server, receiving from a candidate employee in said plurality of employees, a request to create a virtual resume for said candidate employee, said request including said identifier for said candidate employee; said computer server using said identifier received from said candidate employee to search said received employment data for said employer for employment data for said candidate employee; and said computer server creating in a computer-readable medium a virtual resume for said candidate employee, said virtual resume having an employment section automatically populated with said name of said employer, said hire date, said termination date, and said job title of said candidate employee for said employer.

In an embodiment of the method, the method further comprises receiving, at said computer server, a request from a second employer to view said virtual resume; transmitting to a client device of said employer a copy of said virtual resume, said copy including said employment section populated with said name of said employer, said hire date, said termination date, and said job title of said candidate employee for said employer.

In a further embodiment of the method, the method further comprises: in said transmitting, said copy including a visual indication that said name of said employer, said hire date, said termination date, and said job title of said candidate employee for said employer are verified.

### BRIEF DESCRIPTION OF THE DRAWINGS

FIG. 1 is an embodiment of a network using an evidence-based verification platform according to the present disclosure.

FIG. 2 is an embodiment of a method for evidence-based verification of data in a virtual resume according to the present disclosure.

FIG. 3 is an embodiment of a method for automatically populating a virtual resume with verified resume data according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Throughout this disclosure, the term “computer” describes hardware that generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computeray be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices, which are not conventionally thought of as “computers,” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash emory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a web site”), or an access point for a service over a network.

The systems and methods described herein are implemented in the context of a general on-line service for connecting employees, employers, and others (e.g., benefits managers and public officials) while providing for automated validation of data submitted by applicants for employment or public benefits. The systems and methods provide independent data validation and thus reduce the need for duplicative, repetitive validation by each potential employer or public agency.

The systems and methods described are directed to an on-line platform for validating, managing, and sharing employment-related data and information among multiple participants in the hiring process, including candidates for positions, employees, employers, and benefits management organizations, including public benefits organizations. The systems and methods inhibit fraud, improve accuracy, and provide various technological improvements to overcome and address data gaps in existing platforms.

Commonplace features such as, but not limited to, authentication-moderated access, privacy technologies and settings, messaging, display configurations, and so forth, may be included in an embodiment. The platform may be accessed by, among others, candidates for employment seeking a job, employers seeking candidates to fill open positions, unemployed candidates seeking unemployment benefits, or benefits managers or public benefits agencies seeking to confirm eligibility for unemployment benefits. Users who are seeking employment and/or benefits will be referred to herein as “candidate users” and may be further characterized as “employment candidate users” and “benefits candidate users.” Users who are employers seeking works will be referred to herein as “employer users.” Users who are assessing eligibility for benefits will be referred to herein as “benefits users,”

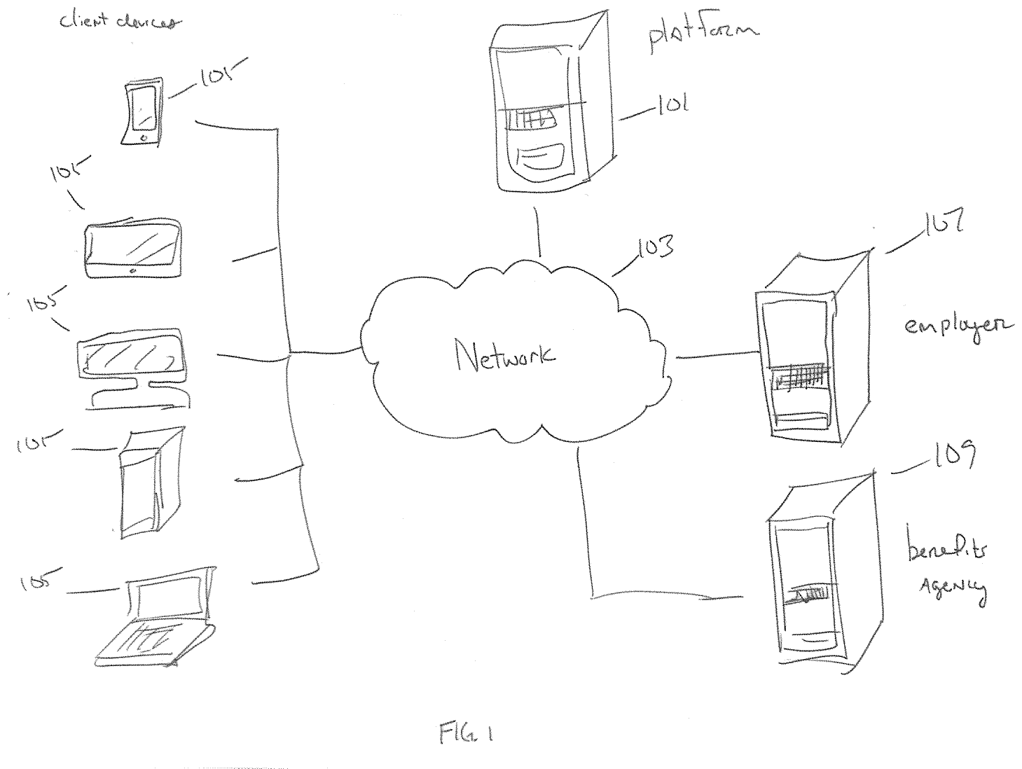

The basic elements of such a system will be understood and intuitive, including the use of a server or server farm to provide access to the platform over a telecommunications network, and access to such a system by client connections via client devices, One such embodiment is depicted in FIG. 1. In the depicted embodiment of FIG. 1, an evidence-based verification platform (101) provides services over a telecommunications network (103) for a job candidate-employer search and match platform. One or more candidate users connect to the platform (101) via the network (103) on a client device (105). In the depicted embodiment, one or more employees (107) and/or benefits agencies (109) also connect to the platform (101) via the network (103) rising a client device.

An aspect of the systems and methods is evidence-based validation of information provided or submitted by various users, but chiefly candidates for employment or benefits. This principle of evidence-based validation runs through many features of the platform. Another aspect of the system is the concept of the “virtual resume.” An on-line platform is not confined by the formatting and content limitations of a sheet of paper, yet on-line job-related platforms continue to organize data based on paper publication requirements. The “virtual resume” concept described herein frees both candidates and employers from the limitations of paper, and also incorporates the evidence-based validation concept.

In an embodiment, generally a candidate user begins by creating a virtual resume. A virtual resume is, conceptually, an on-line representation of a real-world resume, but includes additional functions and features not possible with a paper resume. A virtual resume will generally include data provided by the candidate user (203), in the nature of typical resume content, such as, but not limited to, educational background, employment history, certifications, skills, publications, and references. This information can then be published (211), and employer users can search for and review the virtual resumes to assess the suitability of the candidate for a job. Likewise, if the candidate user applies for the job, they may simply forward a link to the virtual resume to the employer or user. When the employer user reviews the resume, they will see some or all of the information provided by the candidate user. This aspect of the system functions similarly to existing employment platforms.

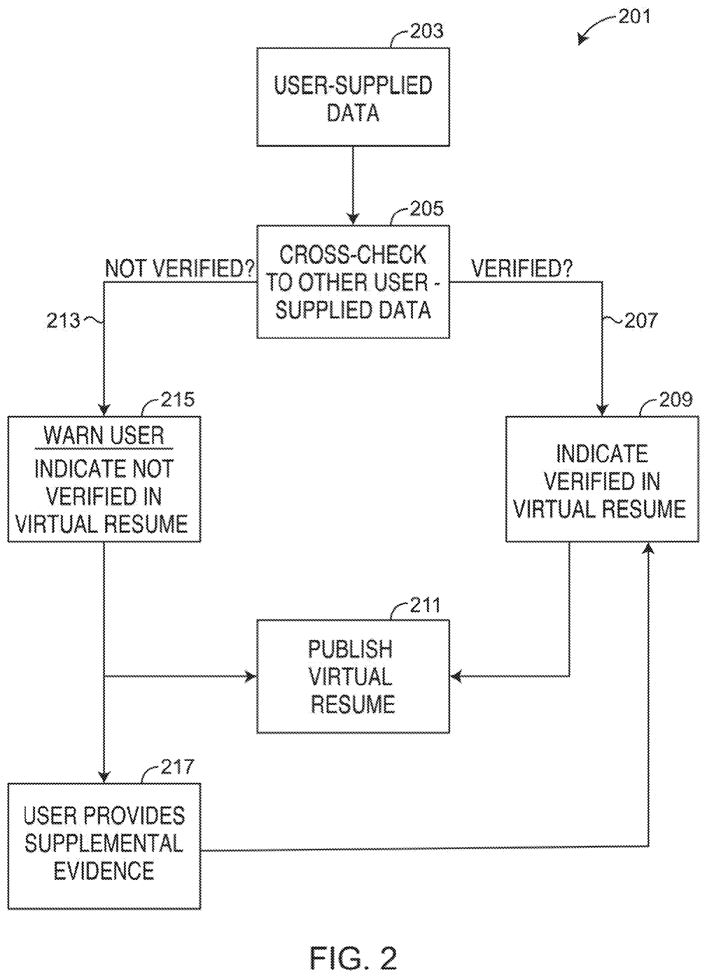

The present systems and methods differ in that they include an evidence-based verification system. An exemplary embodiment of how evidence-based verification may be implemented is depicted in FIG. 2. Some or all of the user-supplied data is independently verified by the platform (205). If the information is able to be verified (207) through sufficient evidence, a visual indication is provided (209) in connection with the verified data. If the information is not able to be verified (213), there may be no indication, or an indication that verification is not possible (215). The verification status (211) is then published to third parties (e.g., employers, benefits agencies)who review the virtual resume.

In another embodiment, the visual indication may reflect that verification was attempted but unsuccessful. This could be for any number of reasons. For example, if a candidate user provides educational credentials, such as that he or she received a specific degree from a specific educational institution, the educational institution itself will generally confirm the degree and date it was received. However, if the candidate user provides in the virtual resume a grade point average, the educational institution may not confirm that information without prior authorization by the candidate user. Thus, the fact of the degree and year may be indicated as verified, but the

GPA may be indicated as unverified. Unverified does can the information is necessarily false; only that it could not be confirmed with sufficient certainty under the operating principles of the evidence-based verification system,

The candidate users may also be warned of unverified information(215) so they can shore up those gaps by providing supplementary evidence (217). For example, the candidate user may contact the educational institution and sign a waiver or form authorizing the release of the GPA information. Alternatively, the candidate user may obtain a certified copy of his or her course history and grades, showing the GPA, and upload that to the platform to verify the GPA.

The amount of scrutiny and the strength of the evidence required to indicate a piece of virtual resume data as “verified” may itself vary from embodiment to embodiment. On a very strict platform, for example, only third party verification may be accepted, or a notarization or sworn statement may be required. On a more relaxed platform, the system may simply accept whatever evidence the user provides and pass that evidence on to the employer to assess independently.

This evidence-based verification feature will also function with employment history. The platform may contact prior employer users for whom a candidate user worked and require them to verify the information provided. Employers commonly verify the dates of hire and termination of employment, and may also provide salary information.

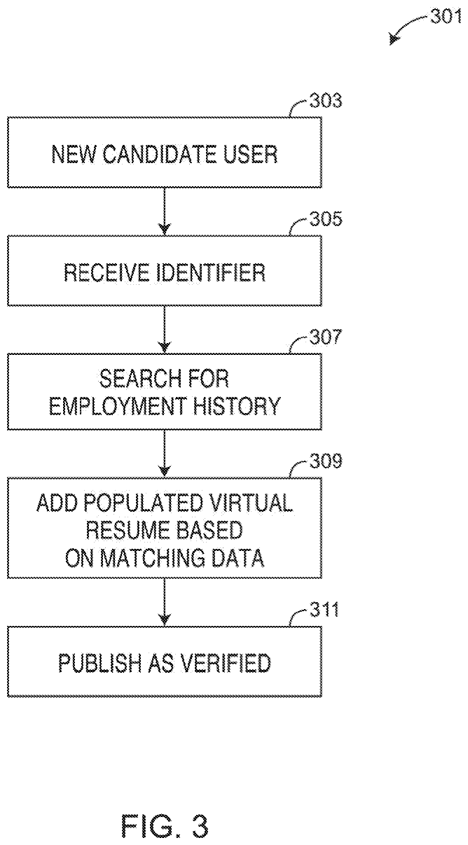

In an embodiment, this could be done automatically, and could be used to automatically populate a virtual resume. An exemplary embodiment (301) is depicted in FIG. 3. For example, employer users may provide to the system a history of employment data. This data could be consulted to confirm that the information provided by a candidate user is accurate, and provide the evidence-based verification. in another embodiment, this data could be used to populate the virtual resume at the outset. That is, when a new user (303) creates a virtual resume, the system may automatically search (307) for corresponding prior employment records for that user, using a unique identifier (305) to prevent false matches (e.g., social security number). The virtual resume could then be populated (309) automatically with employment history data, which is also automatically confirmed valid (311) because it was sourced from the prior employers themselves.

This saves the candidate user the trouble of looking up this information, and potentially making a mistake that causes the resume not to match the employer's records. This type of error can give the impression of carelessly, inattention to detail, or intent to deceive. By automatically finding and populating the data, the system gives the candidate user a starting point. If there are errors in the employer's data, the candidate user may then contact them to correct it.

Another aspect of evidence-based verification is confirming certifications. Similar to employers, a certification agency could enroll on the platform and provide data about who received certifications, and when, and whether those certifications are current. As with employer verification, this could be used to automatically validate information provided by candidate users on their virtual resume, and/or to automatically populate the resume with available data on existing certifications. This not only provides the evidence-based verification but also may alert candidate users to lapsed certifications or errors in records, so they can be corrected before the virtual resume is published.

Much of this data is of course sensitive and confidential, and so the system will have privacy settings and strong security to prevent unintended disclosure. The employee data and certification data, for example, may be held privately by the users and verification may be performed only if the request is authenticated. Techniques for doing this are known. For example, a candidate user seeking to have his or her virtual resume data verified may be separately contacted by the organization in question and provided an authentication code, which is then entered by the user to authorize the request.

The evidence-based verification principle may also be used for benefits candidate users. Requirements for unemployment benefits vary from state to state, but generally speaking, qualifying requires that the candidate was involuntarily dismissed from his or her position, desires to continue working, but has been unable to find new work despite diligent effort However, verifying this effort is time-consuming and difficult, and there is wide opportunities for fraud. This places a drain on public resources and limits the amount of benefits available to those who properly qualify. The platform described here may be leveraged to reduce this. For example, in current practice, unemployment benefits agencies often have to accept at face value the applicant's assertions that he or she was involuntarily discharged.

Using the platform, when an employer dismisses an employee, the employer can indicate whether the employee was involuntarily terminated, or quit. The benefits agency could then accept this as prima facie evidence. If the employer says the employee quit, then the employee can provide contrary evidence proving otherwise (e.g., an e-mail, dismissal letter, or voicemail from the company's human resources department, or if none are available, a sworn statement that the company's records are incorrect). The degree of evidence required to qualify for benefits is ultimately governed by the law and procedures applicable to the agency in question and the system can be modified or configured to conform to the application requirements and rules.

Another aspect of this feature is that evidence that the benefits candidate user is seeking employment and has been unsuccessful in finding it can be automatically provided. The candidate user can apply for positions using the platform, and the fact of these applications (and to whom they applied) can be provided to the benefits agency to prove that the employee is seeking work. Likewise, the fact that the employee has not been hired can be confirmed by the employer users, who provide employment data. An API or other querying mechanism can be used to inquire with each employer whether the candidate was hired. This inquiry may be made or repeated on some frequency in accordance with law (e.g., weekly). Alternatively, the system may require employers to affirmatively verify a hire, which is then automatically reported to the benefits agency. Thus, if a candidate user has no such confirmations, the agency may assume no hire has been made, and continue benefits without requiring frequent check-ins by the candidate user to prove that he or she is still eligible for benefits.

This has efficiency benefits for the agency and the candidate user. By using the system, the candidate user's eligibility for continued benefits is established automatically without the candidate having to divert attention and resources away from seeking new employment. This provides a social benefit as well, as the candidate can be certain of receiving benefits and not experiencing an income disruption caused by administrative or clerical mistakes. Likewise, the platform may inform the candidate user of the benefit amount and how long the benefits will last.

Another feature of this system is that if employers are required to report dismissals, the system will have reasonably current data on the number of recently-terminated employees. For involuntary dismissals, this information may be provided to the benefits agency for budgeting and forecasting purposes. It may be inferred that a significant number of recently terminated employees will seek unemployment benefits. By having this forecasting data, the agency can better budget and plan for future needs,

Another aspect of the evidence-based system can be used for workers who are already employed. Evidence-based verification may be used to confirm arrival and departure times, start and end times, or even workstation status. For example, the system may include a daily “check-in” and “check-out” feature where the employee's license plate number is photographed to confirm arrival and departure times, or the photograph of the employee's workstation is taken upon arrival and departure. This photograph may be taken by the employee or employer, and establishes the status of the workstation when the employee arrives and leaves. This helps to protect the employee from being wrongly accused of having stolen or damaged something that was already missing or broken, and the employer can better determine sources of fraud, damage, or misuse of company property. These photographs can have timestamps and many may also include geographic data from the mobile device which captured the image. This data again provides evidence-based verification that the photo was taken at the properly and expected time and place,

Such photographs may also be used by an employer when an employee is terminated to document any abandoned or uncollected articles left or found at the employee's workstation. The items can then be returned to the employee, such as by shipping them to the employee's address, along with a photo showing what was found and in what state.

Another aspect of both the virtual resume and evidence-based verification is that employees can provide multimedia resume content showcasing their skills and abilities. This type of content cannot be provided in a paper resume. For example, if the candidate is seeking employment as a lifeguard, she could upload a video of her conducting rescue drills or swimming laps to establish her skills and strength. Virtually all non-entry level jobs require at least some basic level of skill, and providing employers the ability to visually assess that skill may help with hiring decisions.

Candidate users may also provide other videos that simply help to humanize the candidate, such as a video of the candidate engaged in activities unrelated to the job but which may be of interest to employer as an insight into the candidate's character and propensity to learn. Resumes often include a “hobby” or “interests” section towards the end that highlights aspects of the candidate unrelated to the job positon, such as playing the piano or painting landscapes. Given the choice between two candidates who are essentially equally qualified on paper, an employer may be more inclined to hire the one who also knows plays the piano. Playing music requires practice and focus, and the ability to do so may be perceived as reflective of desirable personality traits in an employee. Again, by providing the video, the system facilitates evidence-based verification of the facts in the virtual resume.

Social networking aspects may also be added to “crowd source” this type of content to identify notable entries, by providing the community the ability to “like” or share the virtual resume content of others. Metrics on the degree or nature of such activities may provide a sorting or filtering function to help highlight the skills of individual candidate users. For example, if one person uploads a video evidencing an unusual type or degree of skill, and the video is widely shared and “liked,” the platform may highlight or emphasize that particular content, or that particular candidate user, in search results.

The platform may also include a numeric or symbolic rating system for employers to give to employees. These ratings may be kept confidential or unpublished. These ratings may help to identify especially strong or weak candidates based on the experiences of prior employers. Alternatively, a simple question/answer may be used to avoid problems with scalar and ordinal ratings systems. For example, the employer may be asked, “Would you rehire this employee?” to help filter employees who were let go for purely non-performance reasons (e.g,, budget, project cancelled, position eliminated) from those who had performance issues, Employees can be terminated for multiple reasons. An employee may be terminated because his project was cancelled, but the employer might nevertheless feel he was a poor fit and indicate that they wouldn't rehire him, However, other employees on the same project might have performed excellently, and would be rehired, This data could be provided to other potential employers for a candidate user on an individual or aggregated basis (e.g., “97% of prior employers said they would rehire”).

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for automatically populating a virtual resume comprising:
providing a computer server providing network services to client devices over a telecommunications network, said network services comprising a job candidate-employer search platform;
at said computer server, receiving from an employer user via said telecommunications network, a name of said employer and employment data about a plurality of employees of said employer, said employment data for each employee in said plurality comprising a hire date, termination date, job title, and identifier for said each employee;
at said computer server, receiving from a candidate employee in said plurality of employees, a request to create a virtual resume for said candidate employee, said request including said identifier for said candidate employee;
said computer server using said identifier received from said candidate employee to search said received employment data for said employer for employment data for said candidate employee; and
said computer server creating in a computer-readable medium a virtual resume for said candidate employee, said virtual resume having an employment section automatically populated with said name of said employer, said hire date, said termination date, and said job title of said candidate employee for said employer.

2. The method of claim 1, further comprising:
receiving, at said computer server, a request from a second employer to view said virtual resume;
transmitting to a client device of said employer a copy of said virtual resume, said copy including said employment section populated with said name of said employer, said hire date, said termination date, and said job title of said candidate employee for said employer.

3. The method of claim 2, further comprising:
in said transmitting, said copy including a visual indication that said name of said employer, said hire date, said termination date, and said job title of said candidate employee for said employer are verified.
